(19) United States
(12) Patent Application Publication
(10) Pub. No.: US 2026/0344652 A1
(43) Pub. Date: Nov. 5, 2026

(54) SMART DUCK DECOY SYSTEM

(71) Applicant: ROBERT FREEMAN, SAN ANTONIO, TX (US)

(72) Inventor: ROBERT FREEMAN, SAN ANTONIO, TX (US)

(21) Appl. No.: 19/195,306

(22) Filed: Apr. 30, 2025

(51) Int. Cl. A01M 31/06; A01K 29/00; A01M 31/00; G06V 40/10; H04N 7/18

(52) U.S. Cl. CPC A01M 31/06; A01K 29/005; A01M 31/002; G06V 40/10; H04N 7/185

(57) ABSTRACT

A smart decoy system includes a floating decoy having a body, a control board, and a camera. The control board is configured to include a plurality of suites to permit for the capture and transmission of visual data within an environment as well as location information. The camera is coupled to the floatable body and is configured to capture images for storage in the control board as visual data. The system also includes a remote electronic device in wireless communication with the control board to permit 2-way communication. The remote electronic device includes software configured to regulate performance of the decoy and serve as an interface for a user. Images of wildlife can be captured and identified and given location and time information.

### BACKGROUND OF THE INVENTION

### 1. Field of the Invention

The present application relates to an electronic system, and more particularly to a system for tracking and locating fowl decoys.

### 2. Description of Related Art

Duck hunting, an ancient practice spanning cultures and continents, has deep historical roots intertwined with human survival and recreation. Early civilizations, relying on waterfowl for sustenance, perfected techniques to capture these birds for both nourishment and materials. Ancient Egyptian tomb paintings and Mesopotamian texts depict waterfowl hunting scenes, showcasing the historical significance of this activity.

Over time, duck hunting evolved from a necessity to a recreational pursuit. European aristocracy embraced the sport, shaping its modern form. By the 19th century, advancements in firearms and hunting technology transformed duck hunting into a popular pastime for the upper class. In the United States, market hunting led to the decimation of waterfowl populations, prompting conservation efforts like the Migratory Bird Treaty Act of 1918. These measures protected waterfowl, prompting a transition from unrestrained hunting to regulated sport hunting. Today, duck hunting remains a cherished tradition, merging heritage with modern ethical and environmental considerations.

Despite its historical significance and modern popularity, duck hunting presents a range of challenges that impact both the hunting experience and the conservation of waterfowl populations. One key challenge is the difficulty in precisely locating and tracking decoys, which are crucial for attracting ducks. Setting up decoys in the right configuration greatly affects the success of a hunt, but inaccuracies in their placement can result in missed opportunities and frustration. Additionally, identifying incoming ducks in real time can be challenging, leading to situations where hunters may mistakenly shoot the wrong species, violating hunting regulations and jeopardizing the preservation of vulnerable species.

Moreover, changing weather conditions and varying geographical locations add complexity to successful duck hunting. The choice of decoy spread, influenced by weather patterns and local factors, is a nuanced decision that can make or break a hunt. The lack of real-time guidance and recommendations tailored to these conditions often leads to suboptimal outcomes. Lastly, the increasing demand for technological integration in outdoor activities calls for innovative solutions that merge tradition with cutting-edge advancements. Balancing the timeless allure of duck hunting with the convenience and efficiency offered by modern technology presents a challenge that demands a strategic and thoughtful approach. Although strides have been made, shortcomings remain.

### BRIEF SUMMARY OF THE INVENTION

It is an object of the present application to provide a smart duck decoy system configured to capture images in an environment over time to aid in the identification of wildlife and the increasing efficiency of the hunter. Another object is that the system permit network capabilities to facilitate multiple decoys and even multiple individual user systems to be functional together in a single network. Time and location data related to images captured may be stored and viewed by the user on remote electronic devices.

Ultimately the invention may take many embodiments. In these ways, the present invention overcomes the disadvantages inherent in the prior art. The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present design. It is important, therefore, that the claims be regarded as including such equivalent constructions insofar as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a graphic of a smart duck decoy system according to an embodiment of the present application.

FIG. 2 is a chart of admin permissions in the smart duck decoy system of FIG. 1.

FIG. 3 is a chart of hunter-user permissions in the smart duck decoy system of FIG. 1.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The embodiments and method in accordance with the present application overcomes one or more of the above-discussed problems commonly associated with the prior art discussed previously. In particular, The smart duck decoy system of the present application is configured to incorporate both a decoy duck and operable software application that offers a comprehensive solution to the challenges faced by duck hunters, ushering in a new era of efficiency and success in the sport. This innovative IoT-based product leverages GPS/GSM technology to provide hunters with real-time information and strategic insights that enhance their hunting experience. By seamlessly integrating smart decoys equipped with GPS/GSM modules, the Smart Duck Decoy system offers a groundbreaking approach to locating and tracking decoys accurately.

The software application serves as the hunters' command center, offering features such as pin locations through GPS/GSM, bird's-eye view of decoy spreads, weather condition forums, and even duck identification capabilities to name a few. Hunters can visualize their decoy placements on a mobile electronic device, enabling precise setup adjustments based on real-time data. Furthermore, the app's ability to identify incoming ducks through camera and software integration in the decoy revolutionizes duck identification, eliminating the risk of shooting the wrong species and ensuring adherence to conservation guidelines. These and other unique features are discussed below and illustrated in the accompanying drawings.

The embodiments and method will be understood, both as to its structure and operation, from the accompanying drawings, taken in conjunction with the accompanying description. Several embodiments of the assembly may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

Referring now to the Figures wherein like reference characters identify corresponding or similar elements in form and function throughout the several views. The following Figures describe embodiments of the present application and its associated features. With reference now to the Figures, embodiments of the present application are herein described. It should be noted that the articles “a”, “an”, and “the”, as used in this specification, include plural referents unless the content clearly dictates otherwise.

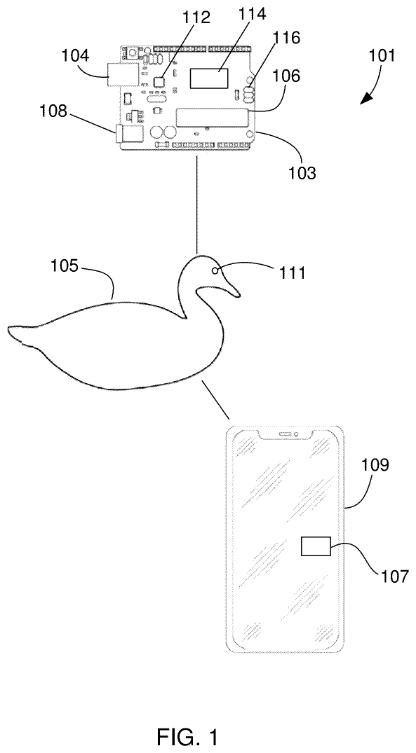

Referring now to FIG. 1 in the drawings, a smart duck decoy system 101 of the present application is illustrated. System 101 is configured to address the issues of decoy placement accuracy, species identification, and tailored recommendations for decoy spread setup. System 101 includes an electronics control board 103, a body 105, and a remote software application 107 operable on electronic devices.

System 101 uses control board 103 to assist in regulating functions within the system. Control board 103 includes a communications suite as well as one or more processors capable of receiving and processing command data between itself and a remote electronic device 109, operating software 107. It is understood that Control board 103 may include one or more modules. For example, a GPS module 106 (global positioning satellite module) may be included which provides accurate location data that may be communicated through communication module 108. Module 108 enables real time communication between the decoy itself as represented by body 105, and the application software 107 on the remote electronic device 109. These modules ensure that the user receives precise tracking and positioning data from body 105 when it is deployed. This provides hunters with a dynamic and responsive setup adaptive to the environment in which it is deployed.

It is understood that Control board 103 includes a power source 104. Power source 104 may include a rechargeable lithium-ion battery or be composed of any other battery material. Naturally given the situational environment in which the system will operate, a portable power source is necessary. System 101 may be recharged at any time through one or more inputs or charging methods. It is understood that the specific layout and configuration of control board 103 is exemplary only as illustrated in the drawings.

Body 105 is a relatively hardened structure formed in the shape of a particular waterfowl. It may include coloring to resemble a specific species and type of bird. It is understood that body 105 is formed and shaped so as to be capable of floating on the surface of water. Body 105 may include one or more cameras 111 that are coupled to, and in communication with, board 103. Images from cameras 111 may be transmitted and processed through board 103 so as to be displayed via electronic device 109 within software 107. These images may be used by a user to identify various waterfowl species nearby and in general develop a real time evaluation of the situation on the water.

It is understood that board 103 is located within some portion of body 105. It is understood that cameras 111 may be located on any portion of body 105 and that its inclusion into the eyes of body 105 are exemplary in nature. Additionally, system 101 may include a storage database 112 on control board 103 configured to store images captured from cameras 111, location data from module 106, and communication data from module 108. Any and/or all of this data may be correlated to one another and transmitted to remote device 109.

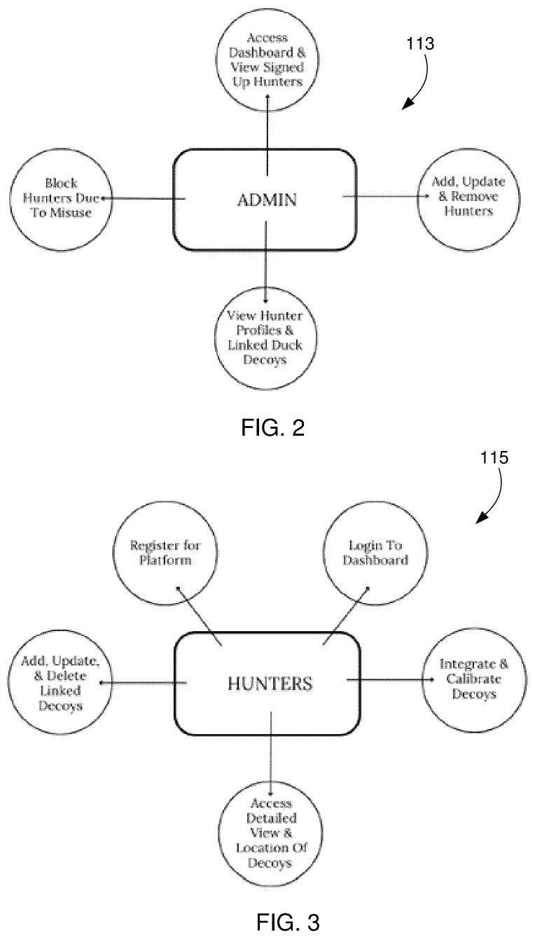

Referring now also to FIGS. 2-3 in the drawings, a chart of both admin and hunter-user permissions are illustrated for use with application 107. Application 107 is displayable upon device 109 and serves as a central hub for hunters and other users to engage and view data provided by board 103 in body 105. Users may access GPS pin locations of decoys which are stored from past time periods or as seen in real time. This is helpful in viewing an overhead bird's eye view of its location on the water. A user may see location data related to the location of body 105 over time.

Software application's 107 integration with camera 111 enables a user to identify waterfowl thereby eliminating the risk of shooting the wrong species. Imagery captured by camera 111 is passed through processor 114 on control board 103. Processor 114 is configured to analyze the images and compare them to stored data in database 112. Stored data on database 112 may include species data, such as, pictures of bird and animal species that serves to help identify fowl and other animals seen. Other information may be provided through board 103 such as weather conditions and recommendations to the hunter user related to optimal decoy spread setups to enhance the hunting experience.

Given the remote locations in which hunters may operate, it should be understood that board 103 may include a network module 116 that acts as a self-contained SOC, offering seamless connectivity to the hunter's Wi-Fi network. This acts to facilitate data exchange between app 107 and hardware components of board 103. These components collectively ensure a reliable and consistent system operation, enhancing the effectiveness of system 101.

In FIG. 2, admin permissions 113 are shown. Hunters are capable of accessing a dashboard in device 109 that provides admin permissions 113. In one common use, a single user may use one or more decoys (i.e. body 105) within system 101. The user may use admin permissions 113 to regulate data transmissions and operations of the one or more decoys, either collectively or individually within system 101.

Additionally, system 101 may be linked over a network that allows multiple hunters and multiple decoys (one or more from different hunters). Each hunter may have an individual system 101 but wherein each system 101 could be linked over a network to allow some users access to view and receive data from other connected systems in the network. Admin permissions 113 regulates the access granted and the type and amount of data accessible by other users.

An admin has the ability to block any hunter from the network as well as add or update others. The admin may also view hunter profiles as well as a list of linked duck decoys used by those hunters within an overall collective system 101. This illustrates the capability of system 101, that the system may include multiple bodies 105 within a singular network. These may be provided by one or more hunters or admins. When properly linked it is possible that each decoy, though on an individual network or provided by individual hunters, may be viewable across multiple electronic devices through a singular network.

In FIG. 3, hunter permissions 115 are provided. Each hunter may access application 107 to register themselves and log in to a centralized dashboard which permits functional capabilities to each hunter to operate through application 107. As alluded to above, each hunter may add update or even delete linked decoys to the system. Additionally, the hunters may integrate and calibrate those decoys for their particular needs. It is also recognized that each hunter is capable of accessing detailed views through cameras 111 and also location information related to each decoy body 105 and its particular environment.

The current application has many advantages over the prior art including being intended to be both practical and functional. The manufacturer's marketability is enhanced by the relative simplicity of manufacturing and reasonably priced components. Improved identification and smart recommendations benefit the user, which should generate significant market interest in the product.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

1. A smart decoy system, comprising:
a floatable body, the floatable body including;
a control board coupled to the floatable body, the control board configured to include a plurality of suites to permit for the capture and transmission of visual data within an environment as well as location information; and
a camera coupled to the floatable body configured to capture images to be stored in the control board as visual data;
a remote electronic device in wireless communication with the control board to permit 2-way communication, the remote electronic device including software configured to regulate performance of the control board and serve as an interface for a plurality of users;
a GPS module configured to provide location data related to at least the floatable body;
a communication module configured to selectively relay information between the remote electronic device of at least one of the plurality of users and the control board; and
a network module within the control board is configured to permit network communication between the plurality of users;
wherein the control board processes the images and relays the visual data to the remote electronic device for identification over the network to at least one of the plurality of users.

2-4. (canceled)

5. The system of claim 1, further comprising: a second floatable body.

6. The system of claim 5, wherein the second floatable body is in communication with the remote electronic device.

7. The system of claim 5, wherein the remote electronic device is configured to operate both the floatable body and the second floatable body individually.

8. The system of claim 5, wherein the remote electronic device is configured to operate both the floatable body and the second floatable body collectively.

9. The system of claim 5, wherein the remote electronic device is configured to operate both the floatable body and the second floatable body collectively and individually.

10. The system of claim 1, wherein the control board is configured to analyze image data from the camera and compare it to stored data so as to identify animals in the environment.

11. The system of claim 1, wherein a processor of the control board provides suggestions to the user.

12. The system of claim 1, wherein the remote electronic device permits controls over sharing and viewing of data within the system to users in a network.
